(19) United States
(12) Patent Application Publication
(10) Pub. No.: US 2015/0368875 A1
(43) Pub. Date: Dec. 24, 2015

(54) WORKING MACHINE JOYSTICK ASSEMBLY

(71) Applicant: JC Bamford Excavators Limited, Uttoxeter (GB)

(72) Inventors: Rebecca Louise Cook, Uttoxeter (GB); Edward James Hill, Uttoxeter (GB)

(73) Assignee: JC Bamford Excavators Limited, Uttoxeter (GB)

(21) Appl. No.: 14/740,019

(22) Filed: Jun. 15, 2015

(30) Foreign Application Priority Data
Jun. 18, 2014 (GB) 1410893.0

(51) Int. Cl. E02F 9/20; G05G 9/02

(52) U.S. Cl. CPC E02F 9/2004; G05G 9/02

(57) ABSTRACT

A working machine joystick assembly includes a joystick arranged to control one or more functions of a working machine, and a mechanical linkage assembly configured to operatively connect the joystick to spool valves to control the one or more functions. The joystick includes at least two axes of movement, one axis being a twist axis, each axis of movement being configured to mechanically actuate a separate spool valve through the mechanical linkage assembly.

### FIELD OF THE INVENTION

The present invention relates to a working machine joystick assembly, in particular to a joystick assembly for a working machine such as a backhoe loader, loading shovel, telescopic handler, excavator or the like.

### BACKGROUND OF THE INVENTION

A working machine generally comprises a working arm and an attachment connected thereto. The working machine may be in the form of a materials handling vehicle such as a telescopic handler, an excavator, a backhoe loader, etc., with a shovel, bucket or forks, or other attachment connected thereto.

A joystick system is commonly used to control the primary functions of the working arm of the working machine, for example the lift/lower and crowd/dump functions of the working machine.

It is sometimes desirable to have the working machine perform auxiliary functions in addition to the primary functions. For example, in addition to the lift/lower and crowd/dump functions, it may be desirable to have the working machine perform additional functions by attaching an attachment which utilizes one or more hydraulic actuators/motors. Hydraulic actuators may be used in grabs, 6-in-1 shovels and the like. Hydraulic motors may be used in attachments such as earth drills, stump grinders, sweepers etc. Releasable couplings are typically provided near the end of the working arm to provide feed and return supplies of hydraulic fluid from the working machine to the attachment. A spool valve on the working machine controls the flow of hydraulic fluid to and from the couplings.

Accordingly, it is known for working machines to be provided with separate foot or hand controls that operate the spool valve to control these auxiliary functions of the working machine.

However, the provision of separate foot or hand controls increases the complexity of operation of the working machine, take up addition space in what may be a confined operator cabin, and may impact on efficiency of operation of the machine due to the need for the operator to take/remove their hand from the primary control to control the auxiliary function.

The advances in technology have led to the situation where an electronically operated system may be configured to control both the primary and auxiliary functions of the working machine. For example, known systems utilize joysticks with position encoders and electronic switches which are linked via a controller area network (CAN) bus or similar electronic communications protocol to spool valves that are electrically actuated using solenoids. However, the implementation of an electronic operated system in a working machine to control both the primary and auxiliary functions may not be desirable due to the increased costs for such a system.

In addition, environmental and/or market demands or conditions may make it commercially unviable to implement an electronically operated system in a working machine to control both the primary and auxiliary functions.

It is desirable to provide a joystick assembly for a working machine which improves the ease of use of the working machine when performing auxiliary functions at low cost.

### SUMMARY OF THE INVENTION

A first aspect of the invention provides a working machine joystick assembly comprising:
a joystick arranged to control one or more functions of a working machine; and
a mechanical linkage assembly configured to operatively connect the joystick to spool valves to control the one or more functions;
wherein the joystick comprises three axes of movement, each axis of movement being configured to mechanically actuate a separate spool valve through the mechanical linkage assembly.

By means of a joystick assembly in accordance with the invention, additional functions of the working machine may be mechanically actuated in addition to the primary functions of the working machine. As a result, it is not necessary to provide separate foot or hand controls to operate the auxiliary functions of the working machine thus improving the ease of use of the working machine when performing auxiliary functions.

In addition, as the auxiliary functions are performable via a single joystick control, less functions will need to be packaged for within the cab interior of a working machine.

This not only improves the aesthetics within the cab as the interior will look less cluttered and more user friendly, but means that the size of the cab interior can be more compact as it does not need to accommodate an auxiliary control panel/joystick within the cab.

A further benefit of the joystick assembly in accordance with the invention is that an operator will be able to operate the auxiliary functions via the joystick thus reducing the need for the operator to move his/her hand off the joystick.

Preferably, one of the axes of movement defines a twist axis.

A benefit of one of the axes of movement defining a twist axis is that is provides a movement which is more distinct than the movement provided by the other axes of movement. In this way an operator will be able to clearly distinguish the movements of the joystick required to operate the different functions of the working machine.

In exemplary embodiments of the invention wherein the joystick assembly comprises a twist axis, the twist axis is preferably coplanar to a longitudinal axis of the joystick.

In exemplary embodiments, the mechanical linkage assembly comprises a control rod for each axis of movement.

In exemplary embodiments, the mechanical linkage assembly may further comprise a universal joint to permit the joystick to pivot in two axes about a fixed pivot position.

Preferably, the pivotable connection between the joystick and each control rod is on substantially the same level as the fixed pivot position.

Advantageously this prevents movement of the joystick on one axis causing unwanted actuation of a different working machine function.

In exemplary embodiments of the invention wherein the joystick assembly comprises a twist axis, preferably the mechanical linkage further comprises a translation arrangement to convert movement of the joystick about a twist axis into a movement of a control rod in a different direction, more preferably a substantially linear direction. Linear movement advantageously enables the linkage to operate a standard sliding spool valve.

In exemplary embodiments, the translation arrangement comprises a first end coupled to a mounting plate and second end connected to the joystick such that the second end is adapted to move in synchronized movement with the joystick.

Preferably, the mounting plate is connected to fixed portion of the assembly.

In exemplary embodiments, the translation arrangement comprises a lever plate and a coupling plate, the lever plate having a first end pivotably coupled to the mounting plate and a second end connected to the coupling plate at a second end thereof, a first end of the coupling plate being connected to the joystick such that the coupling plate is adapted to move in synchronized movement with the joystick.

Preferably, the translation arrangement further comprises a joint between the first end and the second end thereof to permit a decoupling of the twisting motion of the joystick from the first end.

In exemplary embodiments, the joint comprises a guide rail system.

A benefit of connecting the lever plate to the coupling plate via the guide rail system is that movement of the joystick will be isolated such that only a twist movement of the joystick will be translated to the lever plate with a simple mechanism.

Preferably, the guide rail system comprises a guide plate coupled to the coupling plate, a guide pin positioned within an aperture in the guide plate, and a bracket coupled to the guide pin at each end of the guide pin, each bracket being connected to the lever plate.

In exemplary embodiments, the joystick assembly may further comprise a plurality of spool valves, wherein each control rod is operable to actuate a spool valve.

In exemplary embodiments, the joystick assembly further comprises drive controls for the working machine.

A second aspect of the invention provides a working machine joystick assembly comprising:
a joystick arranged to control one or more functions of a working machine; and
a mechanical linkage assembly configured to operatively connect the joystick to spool valves to control the one or more functions;
wherein the joystick comprises at least two axes of movement, one axis being a twist axis, each axis of movement being configured to mechanically actuate a separate spool valve through the mechanical linkage assembly.

In exemplary embodiments of the invention wherein the joystick assembly comprises a twist axis, the twist axis is preferably coplanar to a longitudinal axis of the joystick.

In exemplary embodiments, the mechanical linkage assembly comprises a control rod for each axis of movement.

In exemplary embodiments, the mechanical linkage assembly may further comprise a universal joint to permit the joystick to pivot in two axes about a fixed pivot position.

Preferably, the pivotable connection between the joystick and each control rod is on substantially the same level as the fixed pivot position.

Advantageously this prevents movement of the joystick on one axis causing unwanted actuation of a different working machine function.

In exemplary embodiments of the invention wherein the joystick assembly comprises a twist axis, preferably the mechanical linkage further comprises a translation arrangement to convert movement of the joystick about a twist axis into a movement of a control rod in a different direction, more preferably a substantially linear direction. Linear movement advantageously enables the linkage to operate a standard sliding spool valve.

In exemplary embodiments, the translation arrangement comprises a first end coupled to a mounting plate and second end connected to the joystick such that the second end is adapted to move in synchronized movement with the joystick.

Preferably, the mounting plate is connected to fixed portion of the assembly.

In exemplary embodiments, the translation arrangement comprises a lever plate and a coupling plate, the lever plate having a first end pivotably coupled to the mounting plate and a second end connected to the coupling plate at a second end thereof, a first end of the coupling plate being connected to the joystick such that the coupling plate is adapted to move in synchronized movement with the joystick.

Preferably, the translation arrangement further comprises a joint between the first end and the second end thereof to permit a decoupling of the twisting motion of the joystick from the first end.

In exemplary embodiments, the joint comprises a guide rail system.

A benefit of connecting the lever plate to the coupling plate via the guide rail system is that movement of the joystick will be isolated such that only a twist movement of the joystick will be translated to the lever plate with a simple mechanism.

Preferably, the guide rail system comprises a guide plate coupled to the coupling plate, a guide pin positioned within an aperture in the guide plate, and a bracket coupled to the guide pin at each end of the guide pin, each bracket being connected to the lever plate.

In exemplary embodiments, the joystick assembly may further comprise a plurality of spool valves, wherein each control rod is operable to actuate a spool valve.

In exemplary embodiments, the joystick assembly further comprises drive controls for the working machine.

A third aspect of the invention provides a working machine joystick assembly comprising:
a joystick configured to control one or more functions of a working machine, the joystick comprising three axes of movement, each axis of movement configured to actuate a different function of the working machine; and
wherein the joystick is moveable in a fourth axis between a first position in which the joystick is moveable about the three axes of movement and a second position wherein a locking mechanism restricts the joystick from twisting about one of said axes of movement.

By means of the joystick assembly in accordance to the third aspect of the invention, twisting movement of the joystick may be selectively restricted when required. This is beneficial where twisting movement of the joystick is adapted to control one or more auxiliary functions and accidental actuation of said auxiliary functions could be adverse to safety or otherwise detrimental to operation of the working machine.

Preferably, the joystick is moveable in the fourth axis to a third position whereby the joystick is restricted from movement about at least two of the three axes of movement.

Being able to restrict the joystick from movement about further axes of movement prevents the possibility of unwanted activation of one of the functions of the working machine.

In exemplary embodiments, the fourth axis is substantially parallel to a longitudinal axis of the joystick.

In exemplary embodiments, the joystick assembly further comprises a detent arrangement to releasably hold the joystick in at least the first and second positions.

Preferably, the locking mechanism comprises complementary formations fixed respectively on a movable and a fixed portion of the assembly, and arranged such that when the second position is adopted, the abutting thereof blocks the twisting motion.

The joystick assembly in accordance with the third aspect of the invention may comprise one or more features of the first and/or second aspect of the invention.

A fourth aspect of the invention provides a working machine comprising a joystick assembly according to any one of the first, second or third aspects of the invention.

Preferably, the working machine further comprises a mechanically operated valve block.

In exemplary embodiments, the working machine is a compact loader.

In exemplary embodiments of the working machine, wherein the joystick comprises three axes of movement, movement of the joystick about the first axis of movement is configured to actuate a first hydraulic actuator connected to a first working arm of the working machine, movement of the joystick about the second axis of movement is configured to actuate a second hydraulic actuator connected to a second working arm of the working machine, and movement of the joystick about the third axis of movement is configured to actuate one or more auxiliary hydraulic functions of the working machine.

Preferably, the first hydraulic actuator controls a lift/lower function of the first working arm.

Preferably, the second hydraulic actuator controls a crowd/dump function of an attachment to the first working arm.

### BRIEF DESCRIPTION OF THE DRAWINGS

Embodiments of the invention will now be described with reference to the accompanying drawings, in which:

FIG. 1 a perspective view of an embodiment of a working machine joystick assembly in accordance with a first aspect and second aspect of the invention;

FIG. 2 is another perspective view of the embodiment of a working machine joystick assembly in accordance with the first and second aspects of the invention showing a direction of movement of the joystick;

FIG. 3 is a view from above of the joystick assembly of FIG. 2 showing three of the four directions of movement of the joystick;

FIG. 4 is a view from the front of the joystick assembly of FIG. 2;

FIG. 5 is a view from the back of the joystick assembly of FIG. 2;

FIG. 6a is a view from a first side of the joystick assembly of FIG. 2;

FIG. 6b is a cross cross-sectional view of the joystick assembly along the line indicated by arrows E in FIG. 6a;

FIG. 6c is an enlarged view of a section of FIG. 6b indicated by arrow F in FIG. 6b;

FIG. 7 is a view from a second side, opposite the first side, of the joystick assembly of FIG. 2;

FIGS. 8a to 8d depict an embodiment of a working machine joystick assembly in accordance with a third aspect of the invention showing the joystick in a first position;

FIGS. 9a to 9c depict the working machine joystick assembly in accordance with the third aspect of the invention showing the joystick in a second position;

FIGS. 10a to 10c depict the working machine joystick assembly in accordance with the third aspect of the invention showing the joystick in a third position; and

FIG. 11 is a schematic view of a working machine and attachment incorporating a joystick assembly in accordance with the invention.

### DETAILED DESCRIPTION OF EMBODIMENT(S)

The preceding discussion of the background to the invention is intended only to facilitate an understanding of the present invention. It should be appreciated that the discussion is not an acknowledgement or admission that any of the material referred to was part of the common general knowledge as at the priority date of the application.

Throughout the description and claims of this specification, the words “comprise” and “contain” and variations of the words, for example “comprising” and “comprises”, mean “including but not limited to”, and is not intended to (and does not) exclude other components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics, and compounds described in conjunction with a particular aspect, embodiment or example of the invention are to be understood to be applicable to any other aspect, embodiment or example described herein unless incompatible therewith.

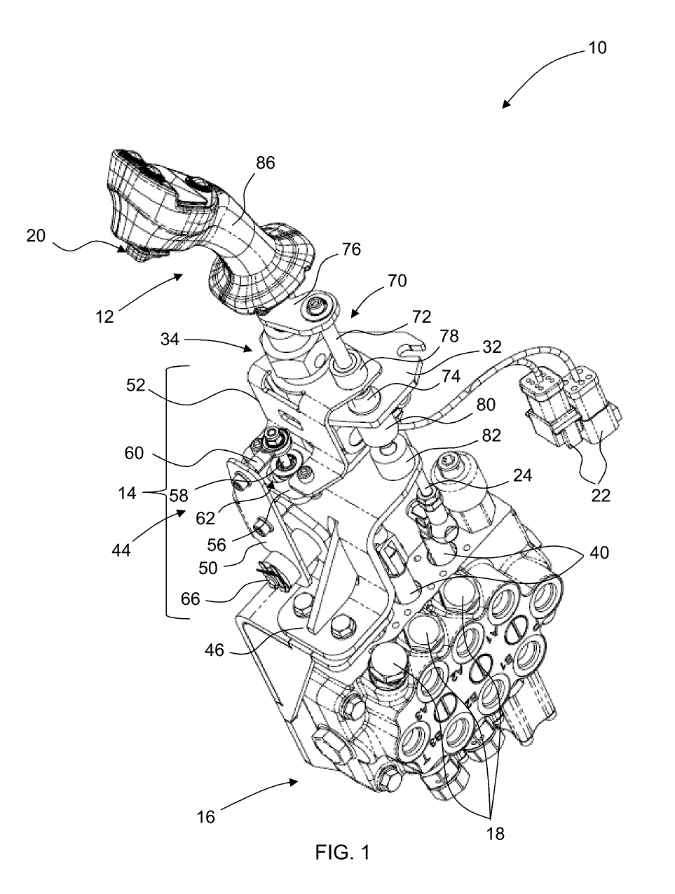

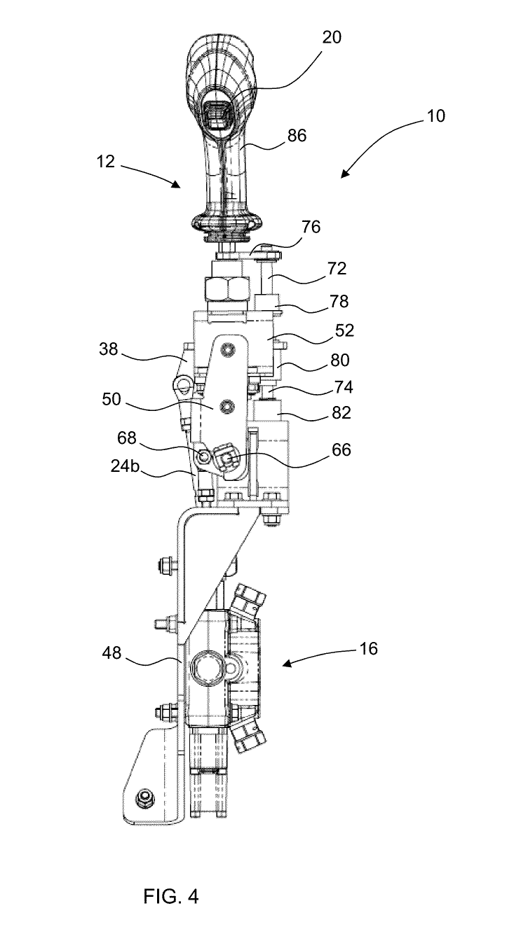

Referring to the FIGS. 1 to 10c, an embodiment of a working machine joystick assembly 10 (herein after referred to as a “joystick assembly”) in accordance with a first aspect and second aspect of the invention is shown.

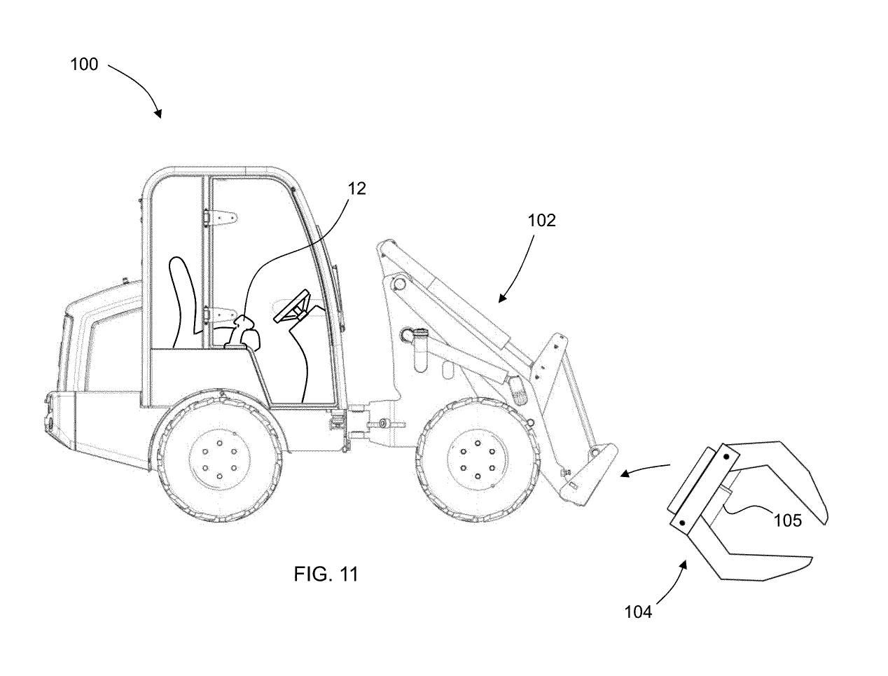

The joystick assembly 10 comprises a joystick 12; a mechanical linkage assembly 14 operatively connected to the joystick 12; and a control valve 16 having a plurality of spool valves 18. The joystick 12 is fitted to a working machine 100 having a working arm 102 (see FIG. 11 which depicts a compact articulated loader) and is configured to control one or more working arm related functions of the working machine 100.

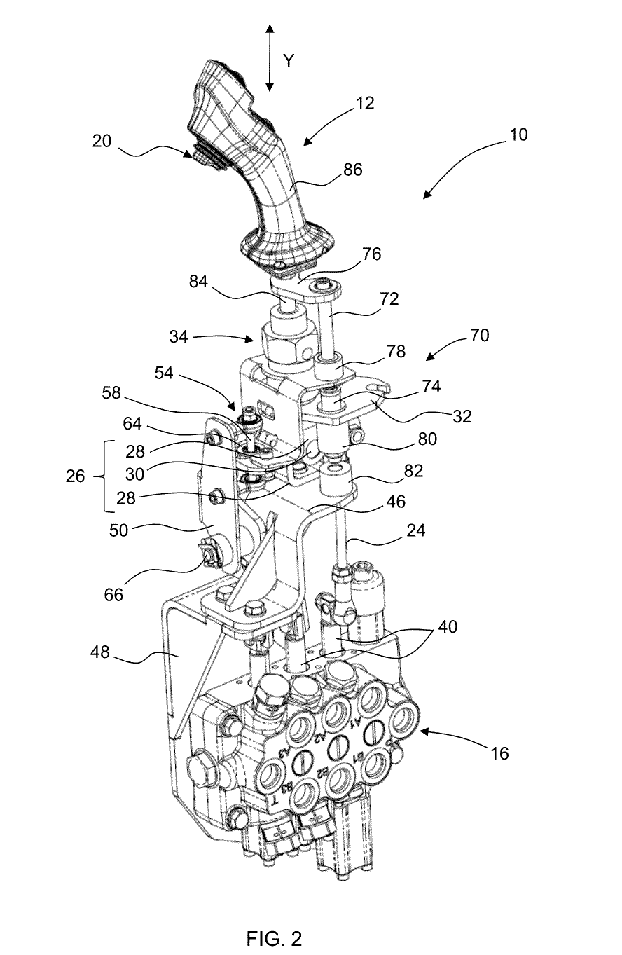

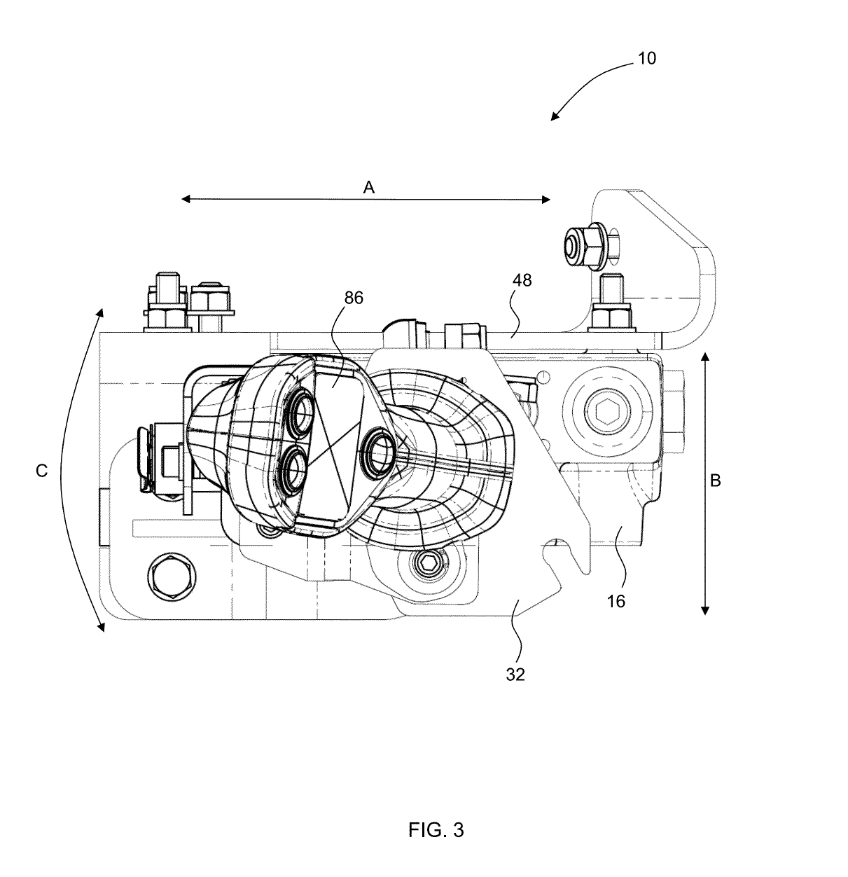

The joystick 12 comprises three axes of movement which allows the joystick to move in the directions indicated by arrows A, B and C in FIG. 3. The joystick 12 is set up such that each axis of movement is configured to mechanically actuate a different working arm related function of the working machine 100 through the linkage assembly 14 and one of the spool valves 18. Further details of how this is done will be described later. The joystick 12 is additionally movable axially (substantially vertically in its normal orientation in use) indicated by arrow Y in FIG. 2.

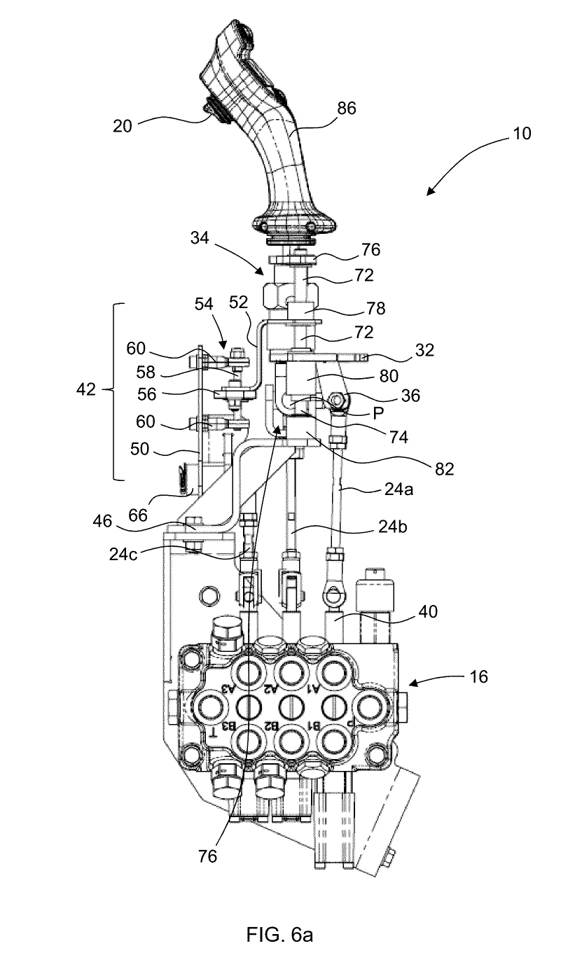

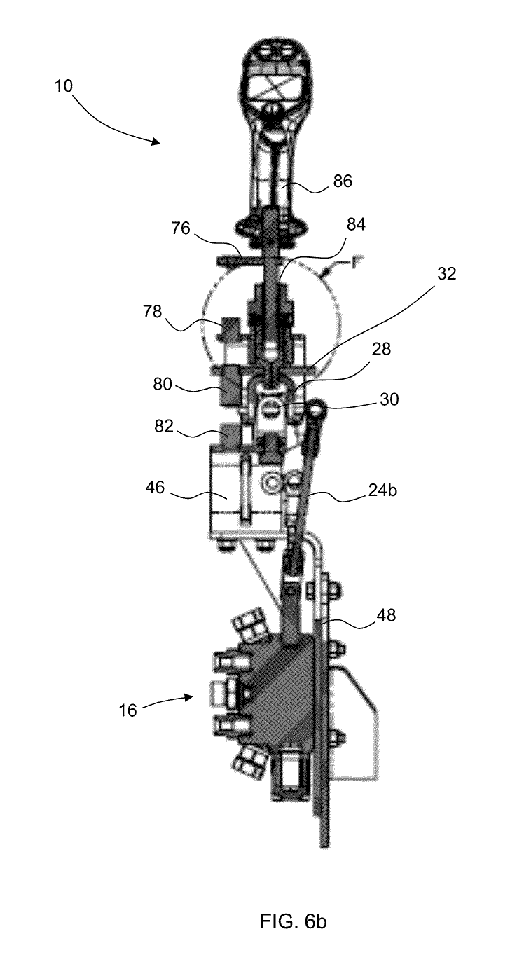

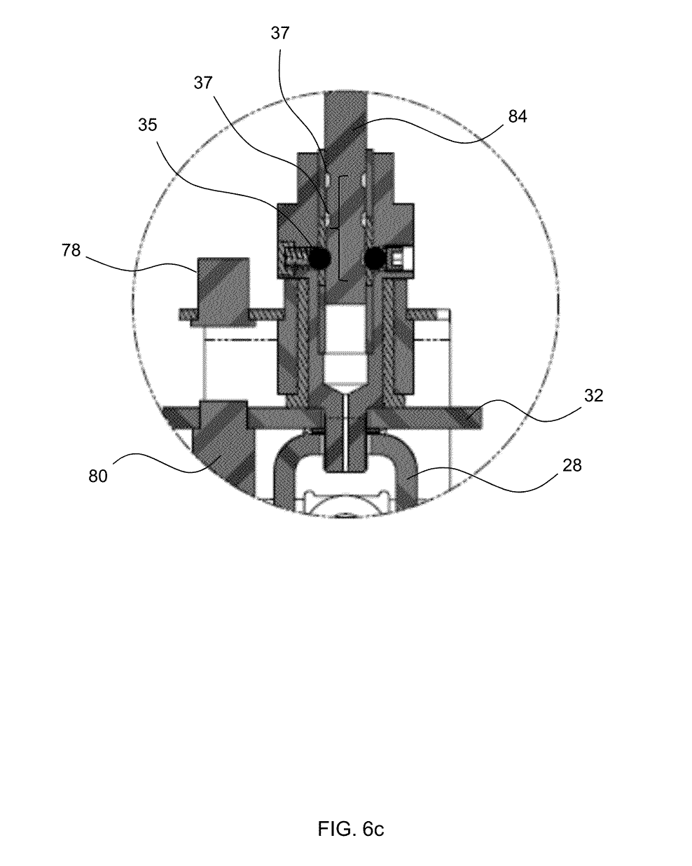

In the embodiment shown, the joystick 12 comprises a handle portion 86 and a shaft portion 84, with the handle portion 86 mounted on the shaft portion 84. The shaft portion 84 is arranged to be received in a joystick mount 34 of the joystick assembly 10, and is able to both rotate and move axially to a limited extent within the mount by virtue of a suitable bearing arrangement within. The joystick mount 34 further comprises a spring loaded detent ball 35 (see FIG. 6c) arranged to extend into one of three annular recesses 37 provided at axially spaced locations on the shaft portion 84 to provide three stable rest positions of the joystick 12 in the Y direction.

As can be seen in FIG. 3, one of the axes of movement defines a twist axis that allows the joystick 12 to twist about the axis as indicated by arrow C in FIG. 3. As can be seen, the twist axis is coplanar to a longitudinal axis of the joystick 12. The “longitudinal axis” of the joystick 12 is the axis defined by the longitudinal direction of the shaft portion 84.

The other two axes of movement define a forward and backward movement of the joystick 12 (arrow A) and a side to side (i.e. lateral or relative left to right) movement of the joystick 12 (arrow B).

In use, the movement of the joystick 12 about the first axis of movement (i.e. forward and backward movement) may be configured to actuate a lift/lower function of the working arm 102, and movement of the joystick 12 about the second axis of movement (i.e. side to side movement) may be configured to actuate a crowd/dump function of the working arm 102. The movement of the joystick 12 about the third axis of movement (i.e. twist movement) is preferably configured to actuate one or more auxiliary functions of the working machine 100. Typically this may be an additional function provided on an attachment 104 that will be mounted to the working arm 102. In this embodiment, the attachment 104 is a grab and the additional function is opening and closing the grab via extension and retraction of a hydraulic actuator 105 provided on the grab. In this way all the working arm related functions of the machine 100 may be actuated by the joystick 12 thus removing the requirement for separate hand or foot controls to actuate the auxiliary functions of the working machine 100.

In this embodiment, the joystick 12 further comprises drive controls 20 for the working machine 100 positioned on a rear side of the joystick 12. It would be understood that the drive controls 20 may be located on a different part of the joystick assembly 10, or even on a different part of the working machine.

In the embodiment shown, the drive controls 20 comprises a three position detented switch. The three positions 20 are adapted to put the working machine 100 into a forward drive mode, neutral, or a reverse drive mode respectively. The switch 20 is connectable to the working machine 100 in order to control the movement thereof by plug connectors 22. It would be understood that the switch 20 may be connectable to the working machine 100 by any suitable means. In other embodiments the switch may be omitted, or replaced by other controls such as a three position slider or three buttons.

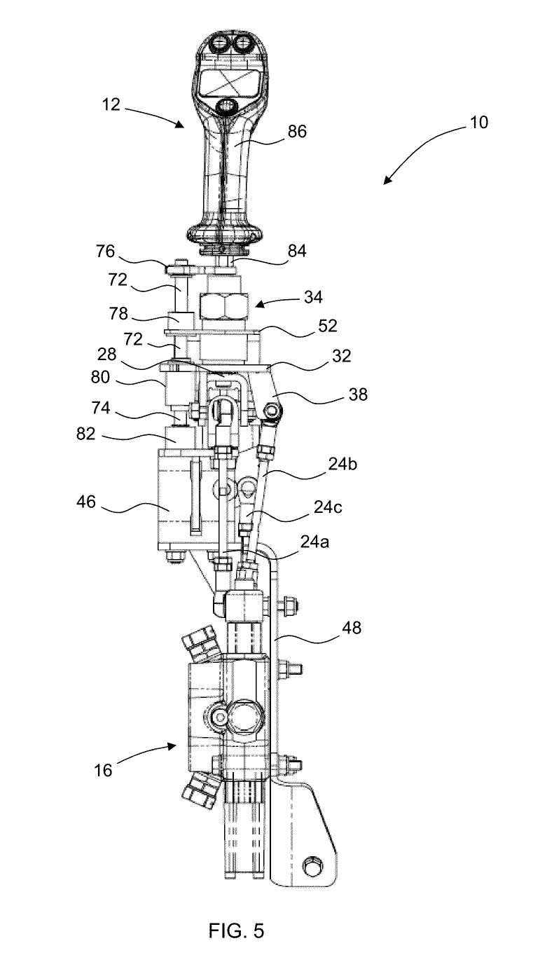

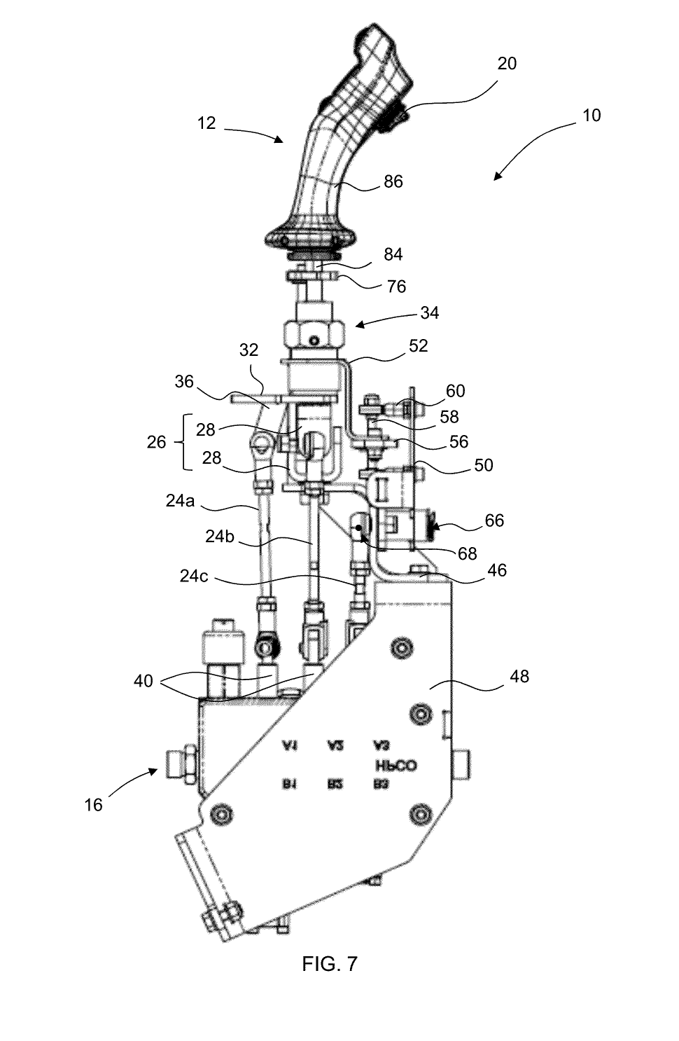

As more clearly seen in FIGS. 5 and 7, the mechanical linkage assembly 14 comprises three control rods 24. The control rods 24 are configured to actuate a different function of the working machine and are each operably associated with a spool valve 18. Each spool valve 18 is a sliding spool valve and comprises a piston/plunger 40 whose movement within the spool valve 18 is adapted to selectively supply fluid to a hydraulic actuator(s) that controls the functions of the working machine such as the movement of an attachment.

The mechanical linkage assembly 14 further comprises a universal joint 26 having a pair of yokes 28 located close together, orientated at 90 degrees to each other and connected by a spider (cross shaft) 30. The universal joint enables the joystick 12 to pivot about a fixed pivot point P at the centre of the spider 30 in any direction.

A link plate 32 is coupled to an end of one of the pair of yokes 28 and is connected to the joystick 12. In the embodiment shown, the link plate 32 is connected to the joystick 12 via the joystick mount 34. The link plate 32 is connected to the joystick 12 such that the link plate 32 maintains a constant angled orientation with the handle portion 86 of the joystick 12. That is to say that the angle between the handle portion 86 of the joystick 12 and the link plate 32 remains constant throughout the movement of the joystick 12. Therefore, tilting of the handle portion 86 will result in the link plate 32 tilting in the same direction but any twisting movement of the joystick 12 will have no effect on the orientation of the link plate 32.

While the mechanical linkage assembly 14 is being described having a universal joint 26, it is to be understood that the mechanical linkage assembly 14 may instead comprise any suitable coupling mechanism/system capable of performing the same functions as described in respect of the universal joint 26.

A first link 36 is connected to the link plate 32, and an end of a first control rod 24a is pivotably connected to the first link 36 at a position that is on the same vertical level as the pivot point P when in the depicted neutral position. A second end of the first control rod 24a is connected to the piston 40 of the associated spool valve 18.

A second link 38 is provided, and like the first link 36, is connected to the link plate 32. An end of a second control 24b rod is pivotably connected to the second link 38 at a position that is also on the same vertical level as the pivot point P when in the neutral position, but is at a right angle to the pivot point between the first control rod 24a and first link 36 in direction C. A second end of the second control rod 24b is connected to the piston 40 of the associated spool valve 18.

The mechanical linkage assembly includes a translation arrangement 42 for translating movement of the joystick about the twist axis into generally linear movement of a control rod 24. The translation arrangement 42 comprises a lever mechanism 44 having a first end coupled to a mounting plate 46 and second end connected to the joystick 12 such that the second end is adapted to move in synchronized movement with the joystick 12.

The mounting plate 46 is connected to an end of the other, fixed, yoke 28 of the universal joint 26. In the embodiment shown, the mounting plate 46 is substantially Z-shaped and is also connected to a mount 48 for the control valve 16 to form a self-contained subassembly.

The lever mechanism 44 further comprises a lever plate 50 and a coupling plate 52.

A first end of the coupling plate 52 is connected to the joystick 12 such that the coupling plate 52 is adapted to move in synchronized movement with the joystick 12. The first end of the coupling plate 52 defines the second end of the lever mechanism 44. In the embodiment shown, the coupling plate 52 is connected to the joystick 12 via the joystick mount 34.

A first end of the lever plate 50 is pivotably coupled to the mounting plate 46 at a pivot point 66 and a second end of the lever plate 50 is connected to the coupling plate 52 at a second end of the coupling plate 52. In this way, the first end of the lever plate 50 defines the first end of the lever mechanism 44.

In the embodiment shown, the coupling plate 52 is substantially Z-shaped and the lever plate 50 is positioned substantially parallel to the central part of the coupling plate 52 at the neutral position shown. It would be understood that the coupling plate 52 may be of any other suitable shape.

With reference to FIGS. 1, 2 and 5 in particular, the lever plate 50 is connected to the coupling plate 52 via a guide rail system 54. The guide rail system 54 enables the twist motion of the joystick 12 in direction C to be transmitted to the lever plate 50 as desired, but is arranged to isolate the lever plate 50 from the pivoting motion of the joystick 12 in any combination of directions A and B.

The guide rail system 54 comprises a guide plate 56 coupled to the coupling plate 52, a guide pin 58 positioned within a slot 62 in the guide plate 56, and a bracket 60 coupled to the guide pin 58 at each end of the guide pin 58. Each bracket 60 is connected to the lever plate 50 above the pivot point 66 of the lever plate 50.

The guide pin 58 is inserted through a rose joint 64 which is housed in the slot 62 in the guide plate 56. At the neutral position, the rose joint 64 is also on the same level as pivot point P.

An end of a third control rod 24c is connected to the lever plate 50 at a position 68 laterally offset from the pivot point 66 of the lever plate 50. In the embodiment shown, the position 68 at which the third control rod 24c is connected to the lever plate 50 is to the side of and slightly above the pivot point 66 of the lever plate 50. A second end of the third control rod 24c is connected to the piston 40 of the associated spool valve 18.

As the lateral offset distance is less than the lever arm between the rose joint 64 and the pivot point 66 of the lever plate 50, there is fulcrum effect which amplifies the force provided to the piston 40 to open the valve. In other embodiments, the lengths of the lever arms may be adjusted to enable a user to supply a reasonable twisting force to move the piston and therefore actuate the auxiliary hydraulic fluid supply to an attachment

The guide rail system 54 isolates the lever plate 50 such that only a twist movement of the joystick 12 is translated to the lever plate 50. Specifically, movement of the joystick 12 in direction A results in pivoting of the rose joint 64, coupled with sliding movement of the rose joint in the slot 62, and the rose joint sliding along the guide pin 58, but no pivoting of the lever plate 50. Movement of the joystick 12 in direction B results in pivoting of the rose joint, but not transmission of the movement to the lever plate 50. Simultaneous movement of the joystick in directions A and B results in a combination of the above, but no pivoting of the lever plate 50.

As a result a mechanical linkage is able to provide three axes of user input without movement in one axis causing unwanted operation of a different function from that desired. Further, the arrangement permits the user to actuate working arm functions by providing input forces that are within acceptable ergonomic limits, and which may enable fine control of hydraulic flow across all three axes, so as to provide proportional control of the auxiliary feed in addition to lift/lower and crowd/dump, which may be desirable in certain operating scenarios.

A joystick assembly in accordance with a third aspect of the invention will now be described. The figures (FIGS. 1 to 10c) show a joystick assembly incorporating the first aspect, the second aspect and the third aspect of the invention, and as such reference numerals relating to all aspect of the invention are shown in all the figures where applicable.

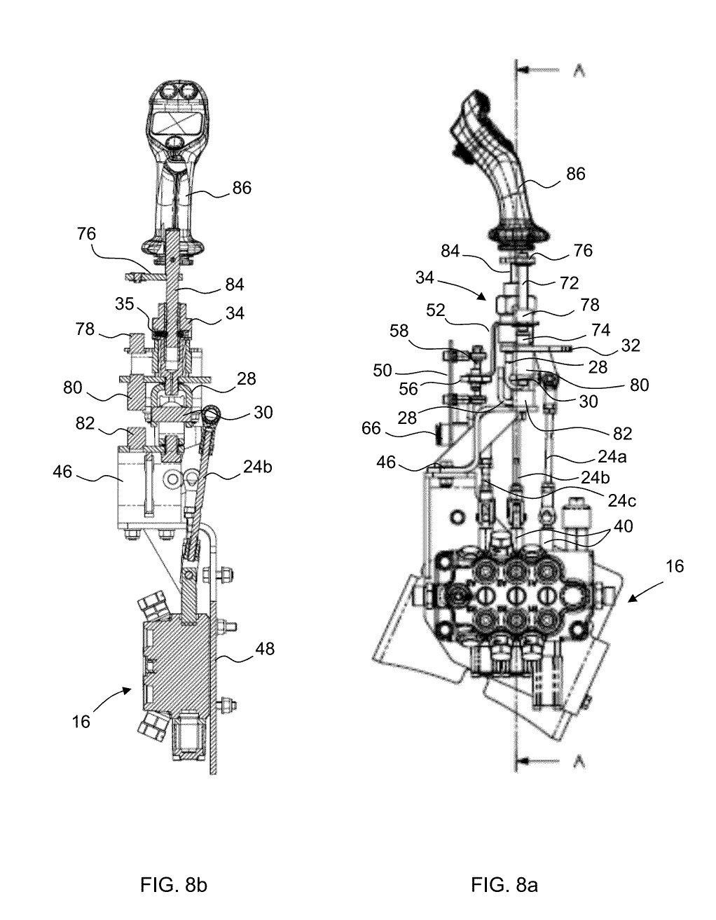

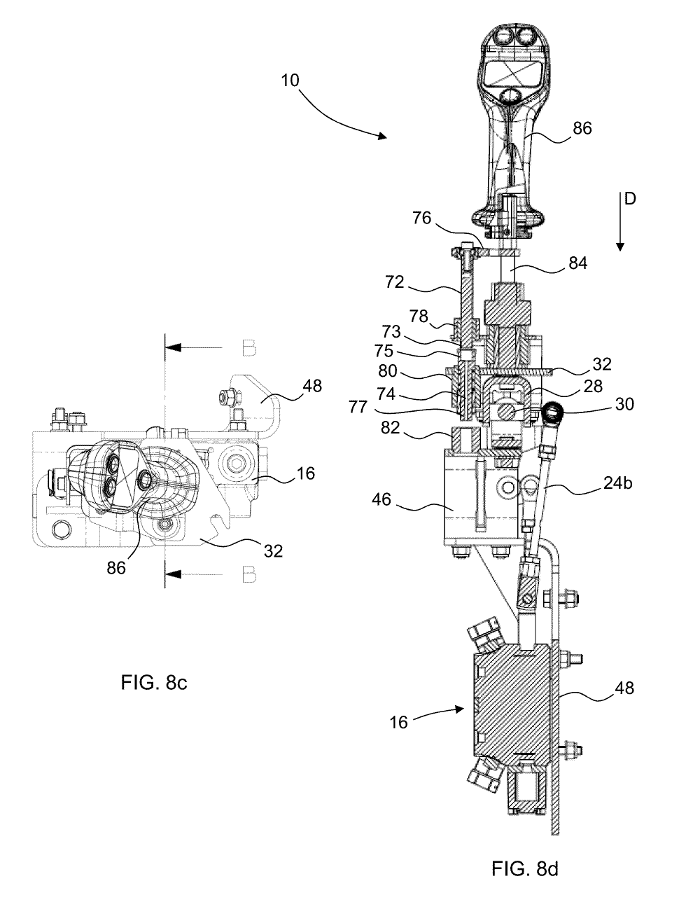

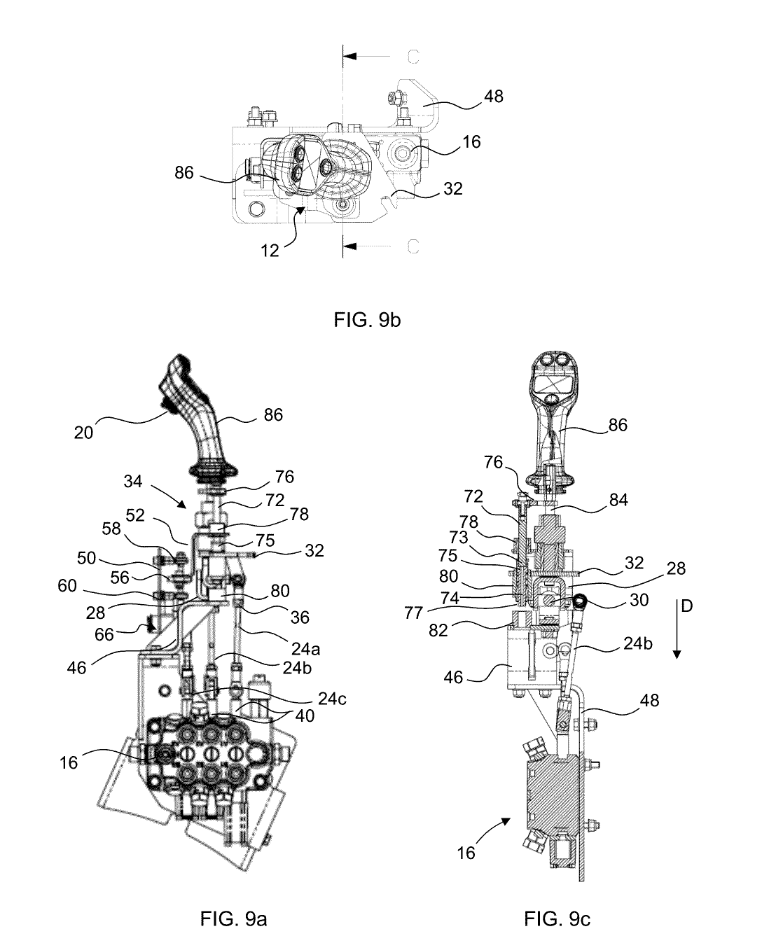

A joystick assembly in accordance with the third aspect of the invention, comprises a joystick 12 adapted to control one or more functions of a working machine, the joystick 12 comprising three axes of movement, each axis of movement configured to mechanically actuate a different function of the working machine through a mechanical linkage assembly 14 operatively connected to the joystick 12. The joystick 12 is also moveable in a fourth axis between a first position (as shown in FIG. 8a-8d) in which the joystick 12 is moveable about the three axes of movement and a second position (as shown in FIGS. 9a-9c) wherein a locking mechanism 70 restricts the joystick 12 from twisting about one of said axes of movement.

The fourth axis is substantially parallel to a longitudinal axis of the joystick 12, and the direction of movement of the joystick 12 about the fourth axis is indicated by arrow Y in FIG. 2.

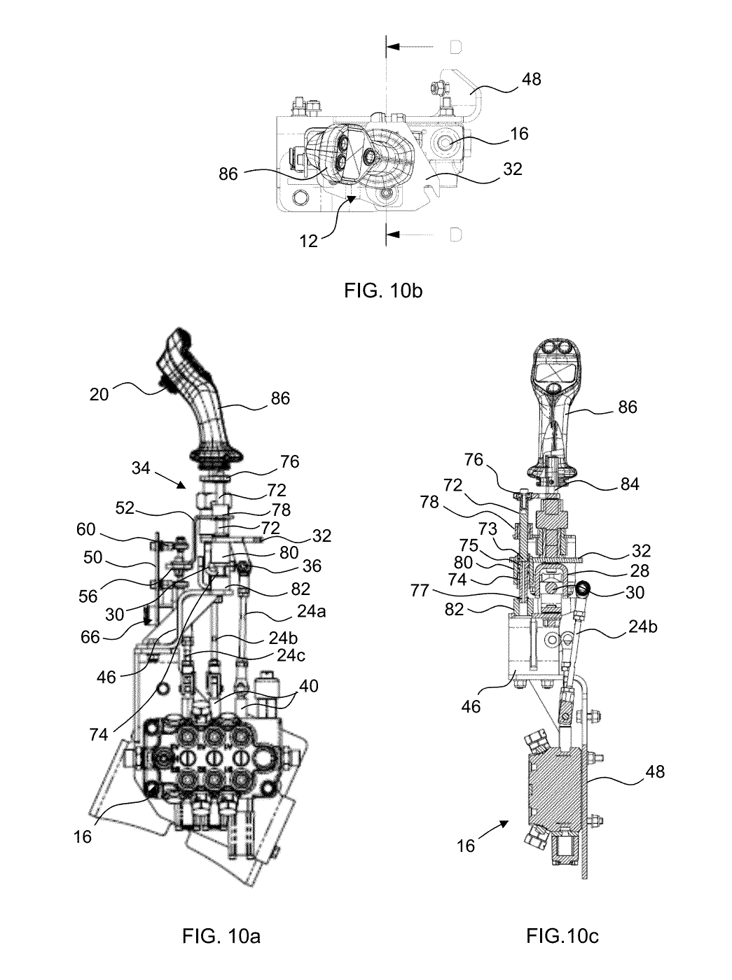

In the embodiment shown, the joystick 12 is also moveable in the fourth axis to a third position (as shown in FIGS. 10a-10c) whereby the joystick is restricted from movement about at least two of the three axes of movement.

The joystick assembly further comprises a detent arrangement to releasably hold the joystick 12 in at least the first and second positions. In the embodiment shown, the detent arrangement comprises a spring loaded detent ball 35 (see FIGS. 6c and 8b) arranged to extend into one of three annular recesses 37 provided at axially spaced locations on the shaft portion 84 to provide three stable rest positions of the joystick 12.

The locking mechanism 70 is connected to the joystick 12 and actuatable by movement of the joystick 12. The locking mechanism 70 comprises a first configuration (see FIG. 8d) wherein the joystick is in said first position, a second configuration (see FIG. 9c) wherein the joystick is in said second position, and a third configuration (see FIG. 10c) wherein the joystick is in said third position.

The locking mechanism 70 comprises a first locking pin 72 coupled to the joystick 12 for movement with the joystick 12. The first locking pin 72 is coupled to the joystick 12 by a connecting member 76 connected to the shaft portion 84 of the joystick 12 in such a way that the movement of the first locking pin 72 is synchronized with the movement of the shaft portion 84 axially and rotationally with respect to the joystick mount 34.

The locking mechanism 70 further comprises a first guide sleeve 78 mounted on the coupling plate 52 so as to be axially fixed, but rotationally moveable with respect to the joystick mount 34 to receive the first locking pin 72 and a second guide sleeve 80 mounted to plate link plate 32 to slidably receive a second locking pin 74.

The first locking pin 72 has a free end 73 which projects below the first guide sleeve.

The second locking pin 74 comprises a first bore 75 at its head which is dimensioned to receive and closely engage with the free end 73 of the first locking pin 72 when aligned. The second locking pin 74 is resiliently biased upwards by a spring within the second guide sleeve 80 up to a limit stop.

A second bore 82 is mounted on the mounting plate 46 in alignment with a free lower end 77 of the second locking pin 74 and dimensioned to receive and closely engage the free end 77 of the second locking pin 74.

Referring to FIGS. 8a to 8d, when the joystick 12 is in the first uppermost position, the first locking pin 72 sits within the first sleeve 78 with the free end 73 of the first locking pin 72 spaced apart from the second locking pin 74. FIGS. 8a and 8c are views of the joystick from the same angle as the views of FIGS. 5 and 3 respectively, while FIG. 8b is a cross-sectional view of the joystick assembly 10 along the line indicated by arrows A in FIG. 8a and FIG. 8d is a cross-sectional view of the joystick assembly 10 along the line indicated by arrows B in FIG. 8c. In this position, all axes of movement of the joystick are available to the operator. In this position, the operator is likely to be working at an operating site and therefore requires all functionality for performing working operations, such as materials handling. The detent ball 35 is in the lowest recess of the shaft 84.

Downward movement of the joystick 12, as indicated by arrow D in FIG. 8d, will move the joystick 12 from the first position towards the second, intermediate position. The downward movement of the joystick 12 results in downward movement of the shaft portion 84 relative to the joystick mount 34. Since the connecting member 76 is connected to the shaft portion 84, it will move downward with the shaft portion 84 and as a result cause the first locking pin 72 to move towards the second locking pin 74, and with the joystick 12 at or near the neutral position, moves into the first bore 75.

FIGS. 9a to 9c depict the joystick in the second position. FIGS. 9a and 9b are similar views to FIGS. 8a and 8c, and FIG. 9c is a cross-sectional view of the joystick assembly 10 along the line indicated by arrows C in FIG. 9b. In the second position, the free end 73 of the first locking pin 72 now sits within the first bore 75 at the head of the second locking pin 74 as shown in FIG. 9c. Since plate 32, and therefore second guide sleeve 80 and second locking pin 74, cannot twist in direction C, the engagement of first locking pin 72 with the second locking pin 74 now blocks the twisting motion of the joystick 12. This prevents operation of the auxiliary spool valve 18. In this position the detent ball 35 is in the middle recess of the shaft 84.

This position may be utilized by an operator when lift/lower and crowd/dump are needed but inadvertent operation of the auxiliary spool valve may be undesirable, e.g. for safety reasons or to prevent spillage of material within an attachment.

Further downward movement of the joystick 12 from the second position, as indicated by arrow D in FIG. 9c, will move the joystick 12 from the second position towards the third position. The downward movement of the joystick 12 results in further downward movement of the shaft portion 84 relatively to the joystick mount 34. Since the connecting member 76 is connected to the shaft portion 84, it will move downward with the shaft portion 84 and as a result cause the first locking pin 72 to move downwards. This will in turn cause the second locking pin 74 to move towards the second bore 82 against the biasing of the spring.

FIGS. 10a to 10c depict the joystick in the third (lowermost) position. FIGS. 10a and 10b are similar views to FIGS. 8a and 8c, and FIG. 10c is a cross-sectional view of the joystick assembly 10 along the line indicated by arrows D in FIG. 10b. In the third position, part of the portion of the second locking pin 74 that protrudes from the end of the second guide sleeve 80 is received within the opening in the second bore 82 as shown in FIG. 10c (assuming the joystick is at the neutral position).

Since the second bore 82 is mounted to the mounting plate, which does not pivot, and the second locking pin 74 is a close fit, all movement of the joystick 12 is prevented by the mounting plate 46 restricting rotational and/or directional movement of the first locking pin 72 via the second locking pin and hence the shaft portion 84 of the joystick 12. In this position the detent ball 35 is within the uppermost recess of the shaft 84.

This third position may be used in e.g. roading operations when any movement of the working arm from a selected roading position, or operation of the auxiliary function is unsafe. In addition, it may be used when a desired position of the working arm is adopted for a grading or other operation, and inadvertent movement from that position may result in e.g. an incorrect level of material on the ground being achieved.

The joystick assembly according to the first, second or third aspect of the invention may be incorporated into a working machine as shown in FIG. 11. Such a working machine will fall within the scope of the fourth aspect of the invention.

The joystick assembly may be used with a wide variety of working machines, it may be particularly advantageous for smaller working machines, for example a compact loader, mini excavator, skid steer loader or the like, where operator space is limited and the cost of providing electronic control of the spool valves is prohibitive as a proportion of the overall cost of the machine.

Although the present invention has been described above with reference to one or more preferred embodiments, it will be appreciated that various changes or modifications may be made without departing from the scope of the invention as defined in the appended claims. For example, it will be appreciated that the general principles of the linkages disclosed may be adapted for arrangements where for example the valve block is positioned in a different position relative to the joystick. In addition the linkages may be adapted for a joystick having only two axes of movement, one of which is a twist axis.

The three position locking mechanism of the third aspect may be incorporated into joysticks that utilize electrical or pilot hydraulic connections to the spool valves, and still offer benefits over prior art arrangements.

In addition, the invention is not restricted to the details of any foregoing embodiments.

While the invention has been described with reference to a “joystick assembly” comprising a “joystick”, the terms are not intended to be limiting. The invention in essence relates to a working machine control assembly comprising a hand held control device which comprises the features and characteristics of the above described joystick embodiments. The control device may be in the form of a joystick (as described), a knob, a lever, or similar device.

1. A working machine joystick assembly comprising:
a joystick arranged to control one or more functions of a working machine; and
a mechanical linkage assembly configured to operatively connect the joystick to spool valves to control the one or more functions;
wherein the joystick comprises at least two axes of movement, one axis being a twist axis, each axis of movement being configured to mechanically actuate a separate spool valve through the mechanical linkage assembly.

2. A joystick assembly according to claim 1, wherein the twist axis is coplanar to a longitudinal axis of the joystick.

3. A joystick assembly according to claim 1, wherein the mechanical linkage assembly comprises a control rod for each axis of movement.

4. A joystick assembly according to claim 1, wherein the mechanical linkage assembly further comprises a universal joint to permit the joystick to pivot in two axes about a fixed pivot position.

5. A joystick assembly according to claim 4 wherein the mechanical linkage assembly comprises a control rod for each axis of movement, and wherein the pivotable connection between the joystick and each control rod is on substantially the same level as the fixed pivot position.

6. A joystick assembly according to claim 1, wherein the mechanical linkage further comprises a translation arrangement to convert movement of the joystick about a twist axis into a movement of a control rod a different direction, preferably a substantially linear direction.

7. A joystick assembly according to claim 6, wherein the translation arrangement comprises a first end coupled to a mounting plate and second end connected to the joystick such that the second end is adapted to move in synchronized movement with the joystick.

8. A joystick assembly according to claim 7, wherein the mounting plate is connected to fixed portion of the assembly.

9. A joystick assembly according to claim 7, wherein the lever mechanism comprises a lever plate and a coupling plate, the lever plate having a first end pivotably coupled to the mounting plate and a second end connected to the coupling plate at a second end thereof, a first end of the coupling plate being connected to the joystick such that the coupling plate is adapted to move in synchronized movement with the joystick.

10. A joystick assembly according to claim 7, wherein the translation arrangement further comprises a joint between the first end and the second end joint to permit a decoupling of the twisting motion of the joystick from the first end, preferably wherein the joint comprises a guide rail system.

11. A joystick assembly according to claim 10, wherein the guide rail system comprises a guide plate coupled to the coupling plate, a guide pin positioned within an aperture in the guide plate, and a bracket coupled to the guide pin at each end of the guide pin, each bracket being connected to the lever plate.

12. A joystick assembly according to claim 3, further comprising a plurality of spool valves, wherein each control rod is operable to actuate a spool valve.

13. A joystick assembly according to claim 1, the joystick comprising three axes of movement.

14. A joystick assembly according to claim 1, further comprising drive controls for the working machine.

15. A working machine joystick assembly comprising:
a joystick configured to control one or more functions of a working machine, the
joystick comprising three axes of movement, each axis of movement configured to actuate a different function of the working machine; and
wherein the joystick is moveable in a fourth axis between a first position in which the joystick is moveable about the three axes of movement and a second position wherein a locking mechanism restricts the joystick from twisting about one of said axes of movement.

16. A joystick assembly according to claim 15, wherein the joystick is moveable in the fourth axis to a third position whereby the joystick is restricted from movement about at least two of the three axes of movement.

17. A joystick assembly according to claim 15, wherein the fourth axis is substantially parallel to a longitudinal axis of the joystick.

18. A working machine comprising a joystick assembly according to claim 1.

19. A working machine according to claim 18, further comprising a mechanically operated valve block.

20. A working machine according to claim 18, wherein the joystick comprises three axes of movement and movement of the joystick about the first axis of movement is configured to actuate a first hydraulic actuator connected to a first working arm of the working machine, movement of the joystick about the second axis of movement is configured to actuate a second hydraulic actuator connected to a second working arm of the working machine, and movement of the joystick about the third axis of movement is configured to actuate one or more auxiliary hydraulic functions of the working machine.
